(19) United States
(12) Patent Application Publication
(10) Pub. No.: US 2018/0056616 A1
(43) Pub. Date: Mar. 1, 2018

(54) BEAD WIRE PAYOFF SYSTEM

(71) Applicants: Bartell Machinery Systems, L.L.C., Rome, NY (US); DW-National Standard-Stillwater LLC, Stillwater, OK (US)

(72) Inventors: John R. Russo, Marcy, NY (US); Paul Gatley, Halland Patent, NY (US); Kevin Razy, Lee Center, NY (US); Walter Thompson, Lindsay, CA (US); Christopher Johnson, Blossvale, NY (US); Kimars Mahmoodi, Stillwater, OK (US)

(21) Appl. No.: 15/686,335

(22) Filed: Aug. 25, 2017

Related U.S. Application Data
(60) Provisional application No. 62/381,872, filed on Aug. 31, 2016.

(51) Int. Cl. B29D 30/32

(52) U.S. Cl. CPC B29D 30/32

(57) ABSTRACT

A bead wire payoff system is provided having a first coil mount configured to receive a first coil of bead wire and a second coil mount configured to receive a second coil of bead wire. The first and second coil mounts are configured to continuously pay-off a bead wire, first from the first coil of bead wire, and then from the second coil of bead wire upon exhaustion of the first coil of bead wire.

### CROSS-REFERENCE TO RELATED APPLICATIONS

The present patent document claims the benefit of the filing date under 35 U.S.C. §119(e) of Provisional U.S. Patent Application Ser. No. 62/381,872 filed Aug. 31, 2016, which is hereby incorporated by reference.

### FIELD

The present disclosure relates to a bead wire payoff system.

### BACKGROUND

The statements in this section merely provide background information related to the present disclosure and may not constitute prior art.

Bead wire is used in the tire industry to reinforce and secure the connection point between the tire and the rim of the wheel. Bead wire is generally a continuous wire made of steel or other material that is wound around the inside rim of the tire to create a ridge that engages the rim of the wheel. Bead wire is generally manufactured and delivered to tire manufacturers as a large reel of wire that is then unwound with a bead wire payoff machine onto the tires.

Known bead wire payoff systems have several drawbacks. For example, the bead wire reel must be rotated continuously to unwind the bead wire from the reel. As is well-known, moving parts, such as a rotating reel of bead wire, have several drawbacks, including wear and tear, noise, and increased risk of injury to operators. Known bead wire payoff systems also cannot run continuously. Once a reel of bead wire has been spent, the entire tire bead wire manufacturing process must be shut down while operators manually exchange the exhausted reel of bead wire with a new reel. This shutdown and manual replacement of bead wire reels results in lowered productivity and increased labor needs.

Therefore, it is desirable to have a bead wire payoff system that can continuously payoff bead wire with limited or no stoppage time. It is also desirable to have a bead wire payoff system with a limited number of moving parts.

### SUMMARY

In one form of the present disclosure, a bead wire payoff system is provided. The bead wire payoff system comprises a first coil mount configured to receive a first coil of bead wire and a second coil mount configured to receive a second coil of bead wire. Further, the first and second coil mounts are configured to continuously pay-off a bead wire, first from the first coil of bead wire, and then from the second coil of bead wire upon exhaustion of the first coil of bead wire. The bead wire payoff system may also include the first coil mount being configured to receive a third coil of bead wire to replace the first coil of bead wire upon exhaustion of the first coil of bead wire, wherein the first and second coil mounts are further configured to continuously pay-off a bead wire, first from the first coil of bead wire, then from the second coil of bead wire upon exhaustion of the first coil of bead wire, and then from the third coil of bead wire upon exhaustion of the second coil of bead wire. Further, the first coil and second coil mounts may be configured to passively pay-off the bead wire from the first and second coils of bead wire. Further, the second coil mount may be configured to automatically begin paying-off the bead wire from the second coil of bead wire upon exhaustion of the first coil of bead wire via a back end of the first coil of bead wire attached to a lead end of the second coil of bead wire.

In another form of the present disclosure, a bead wire payoff system is provided. The bead wire payoff system comprises a first coil mount, a first coil of bead wire attached to the first coil mount, a second coil mount, and a second coil of bead wire attached to the second coil mount. Further, the first coil of bead wire is configured to pay-off a bead wire and the second coil of bead wire is configured to automatically begin paying-off the bead wire from the second coil of bead wire upon exhaustion of the first coil of bead wire. Also, the bead wire is continuous from the first coil of bead wire to the second coil of bead wire.

In yet another form of the present disclosure, a method of paying-off bead wire is provided. The method comprises loading a first coil of bead wire on a first coil mount, loading a second coil of bead wire on a second coil mount, attaching a back end of the first coil of bead wire to a lead end of the second coil of bead wire, and paying-off a bead wire from the first coil of bead wire. The method further comprises paying-off the bead wire from the second coil of bead wire after the bead wire from the first coil of bead wire has been payed-off, wherein the bead wire is automatically payed off from the second coil of bead wire after the bead wire from the first coil of bead wire has been payed-off.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a drawing of a bead wire payoff system in accordance with an embodiment of the disclosure;

FIG. 2 is a drawing of a coil mount;

FIG. 3 is a drawing of a bead wire payoff system loaded with coils of bead wire;

FIG. 4 is a drawing of a bead wire payoff system during transfer from a first coil to a second coil of bead wire;

FIG. 5 is another drawing of a bead wire payoff system during transfer from a first coil to a second coil of bead wire;

FIG. 6 is yet another drawing of a bead wire payoff system during transfer from a first coil to a second coil of bead wire;

FIG. 7 is a drawing of a bead wire payoff system after installation of a new coil of bead wire;

FIG. 8 is a drawing of a bead wire payoff system loading coils of bead wire;

FIG. 9 is a drawing of a coil of bead wire with protective covers;

FIG. 10 is another drawing of a coil of bead wire with protective covers; and

FIG. 11 is yet another drawing of a coil of bead wire with protective covers.

### DETAILED DESCRIPTION

The following description is merely exemplary in nature and is not intended to limit the present disclosure, application, or uses. It should be understood that throughout the drawings, corresponding reference numerals indicate like or corresponding parts and features. It should also be understood that various cross-hatching patterns used in the drawings are not intended to limit the specific materials that may be employed with the present disclosure. The cross-hatching patterns are merely exemplary of preferable materials or are used to distinguish between adjacent or mating components illustrated within the drawings for purposes of clarity.

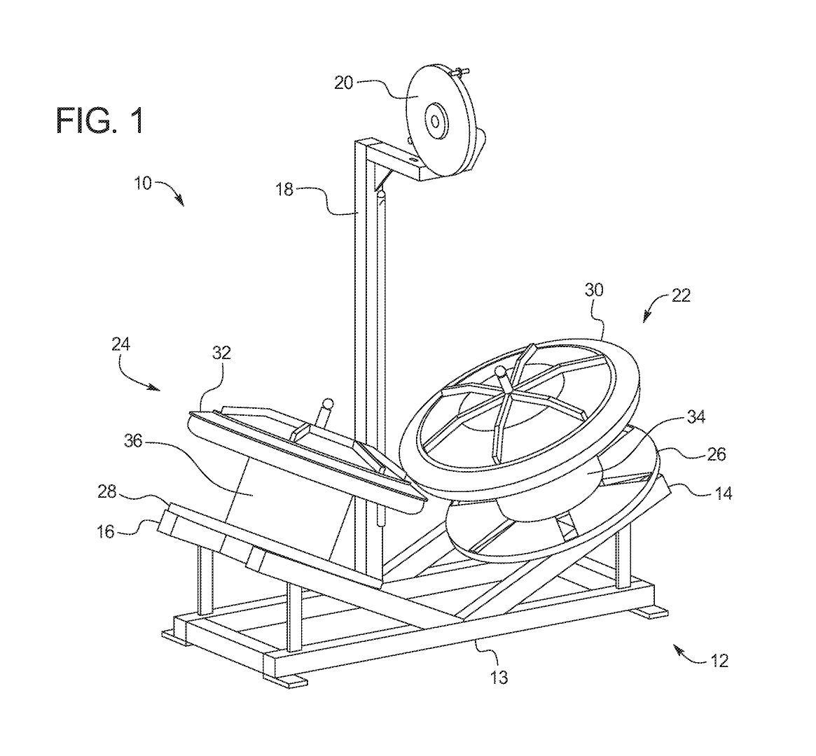

FIG. 1 shows a bead wire payoff system 10 with a support frame 12. The support frame 12 may include a horizontal support 13 that includes a first coil support 14 and a second coil support 16. A vertical support 18 may extend vertically from the horizontal support 13. A pulley 20 may be rotatably mounted on the vertical support 18 through a variety of means well known in the art.

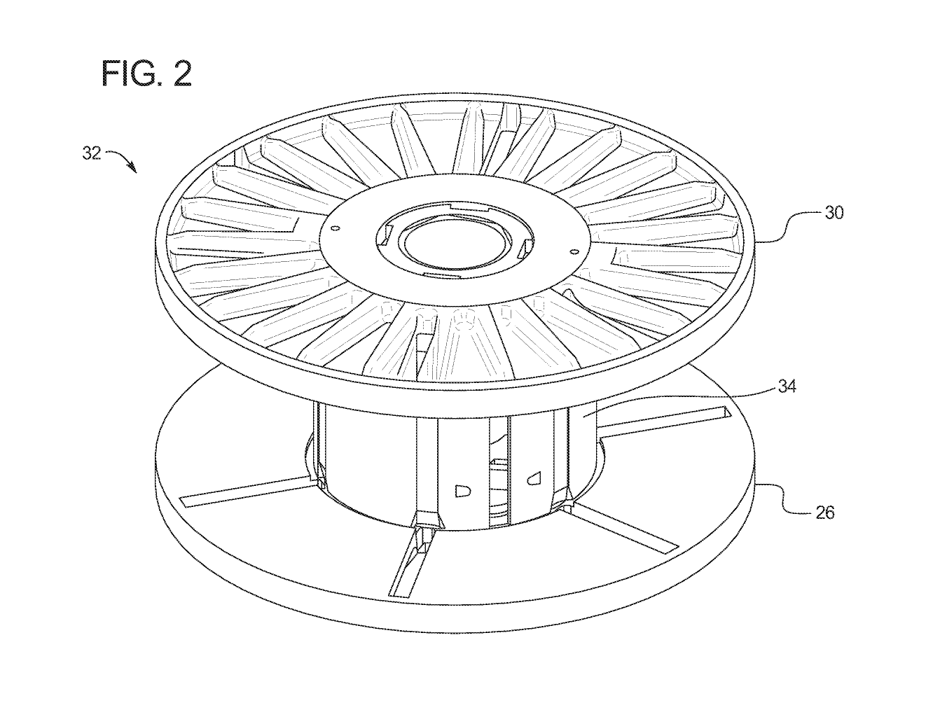

A first coil mount 22 may be mounted to the first coil support 14 and a second coil mount 24 may be mounted to the second coil support 16. The first coil mount 22 is shown in more detail in FIG. 2. The second coil mount 24 may be similar or identical in design to the first coil mount 22. The first coil mount 22 may have a first bottom flange 26 (second bottom flange 28 on the second coil mount 24), a first top flange 30 (second top flange 32 on the second coil mount 24), and a first central core 34 (second central core 36 on the second coil mount 24) connecting the first bottom flange 26 and the first top flange 30 together. The top flanges 30, 32 may be removed from their respective coil mounts 22, 24 to allow for coils of bead wire (not shown) to be mounted around the central cores 34, 36. The top flanges 30, 32 may then be reattached to their respective coil mounts 22, 24 to secure the coils of bead wire. The spent coils of bead wire may be removed and new coils of bead wire may be attached repeatedly as desired.

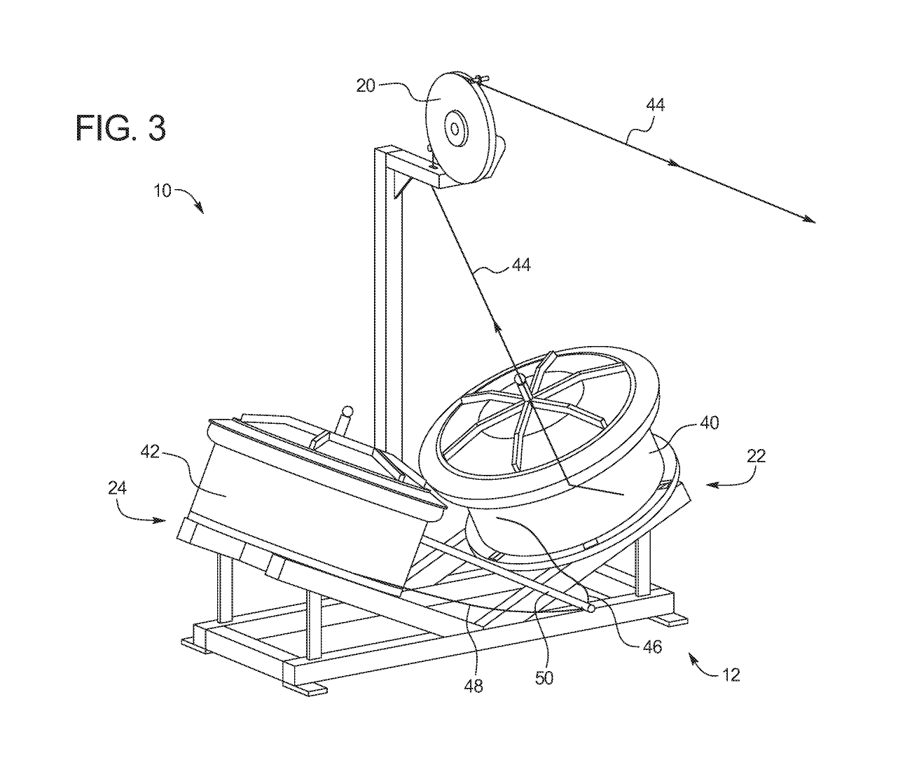

Referring now to FIG. 3, the bead wire payoff system 10 is shown with a first coil of bead wire 40 mounted on the first coil mount 22 and a second coil of bead wire 42 mounted on the second coil mount 24. As can be seen, the bead wire 44 is fed from the first coil of bead wire 40, around the pulley 20, and to an output location (not shown). Also, the back end 46 of the first coil of bead wire 40 extends outside of the first coil of bead wire 40 and thus is accessible to an operator. The back end 46 of the first coil of bead wire 40 can then be connected to the lead end 48 of the second coil of bead wire 42 through a variety of methods including, but not limited to, welding. An arm bar 50 may be connected to the support frame 12 to assist in guiding the back end 46 of the first coil of bead wire 40 to the lead end 48 of the second coil of bead wire 42. This connection between the back end 46 of the first coil of bead wire 40 and the lead end 48 of the second coil of bead wire 42 allows for a continuous length of bead wire 44 between the first and second coils of bead wire 40, 42. Thus, as the first coil of bead wire 40 is unwound and eventually exhausted, the bead wire payoff operation may be automatically switched over to the second coil of bead wire 42 without interruption.

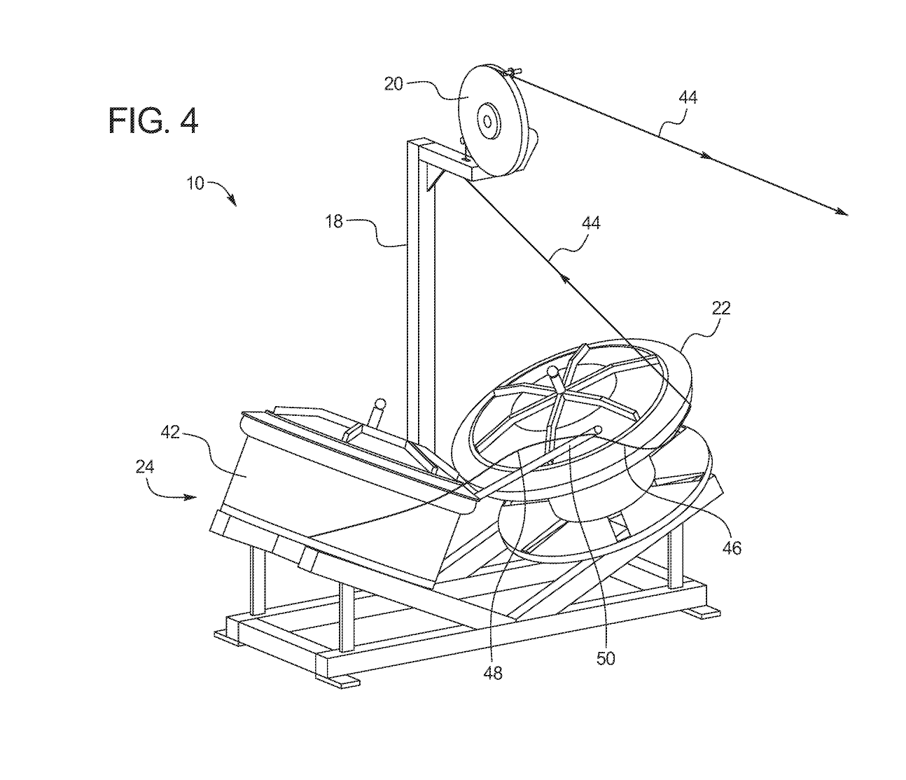

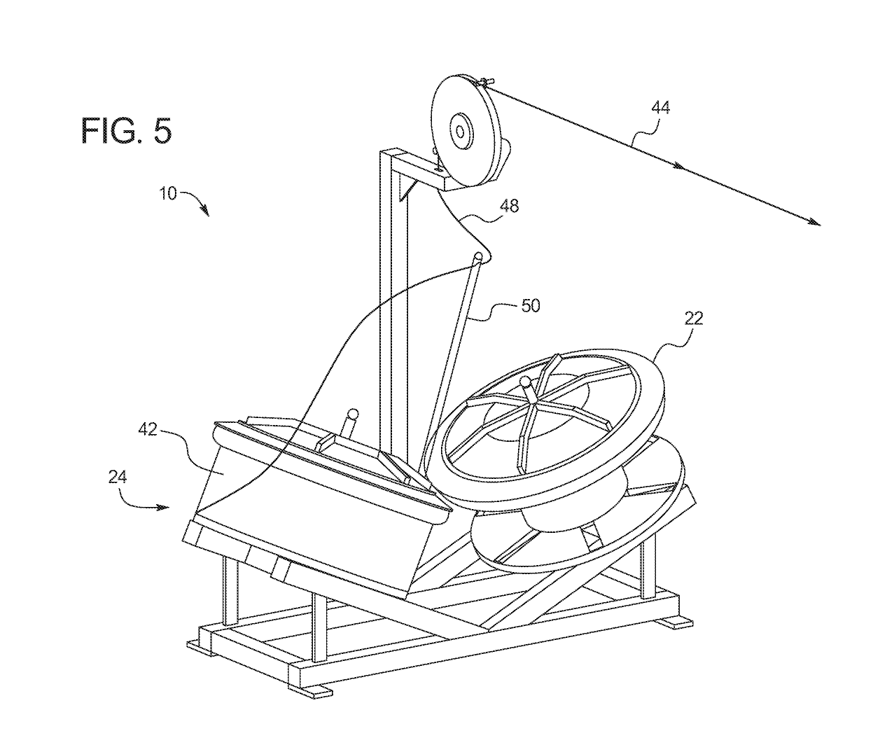

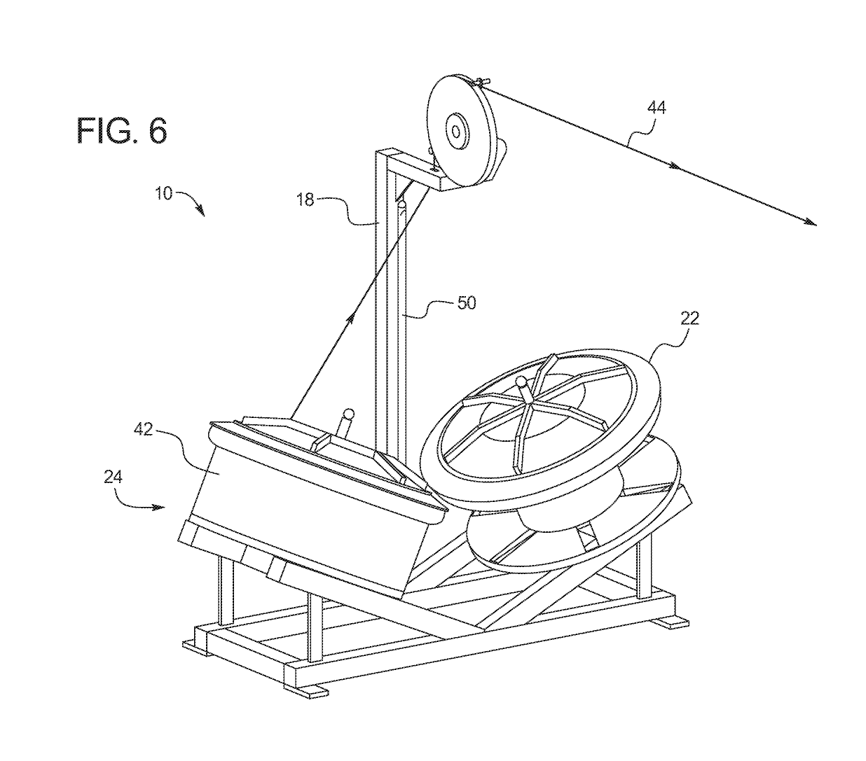

FIG. 4 shows the beginning of this transition from the first coil of bead wire 40 to the second coil of bead wire 42. As seen, the first coil of bead wire 40 has been completely unwound from the first coil mount 22. Since the lead end 48 of the second coil of bead wire 42 is connected to the end 46 of the first coil of bead wire 40, the lead end 48 of the second coil of bead wire 42 will start to receive the tension applied to the bead wire 44 by the bead wire payoff process. As the final amount of bead wire 44 from the first coil of bead wire 40 is unwound, this tension applied to the lead end 48 of the second coil of bead wire 42 causes the arm bar 50 to rotate upwards towards the pulley 20. This arm bar 50 may help maintain adequate tension in the bead wire 44 during the transition from the first coil of bead wire 40 to the second coil of bead wire 42 while also guiding the bead wire 44 to ensure a smooth transition. As the bead wire 44 continues to be pulled from the bead wire payoff system 10, the arm bar 50 continues to rotate upwards towards the vertical support 18, as is shown in FIG. 5. As this is happening, the bead wire 44 begins to unwind from the second coil of bead wire 42. Eventually, as shown in FIG. 6, the arm bar comes to a rest against the vertical support 18 and the transition from the first coil of bead wire 40 to the second coil of bead wire 42 is complete. At this time, the remaining bead wire 44 from the second coil of bead wire 42 may be unwound.

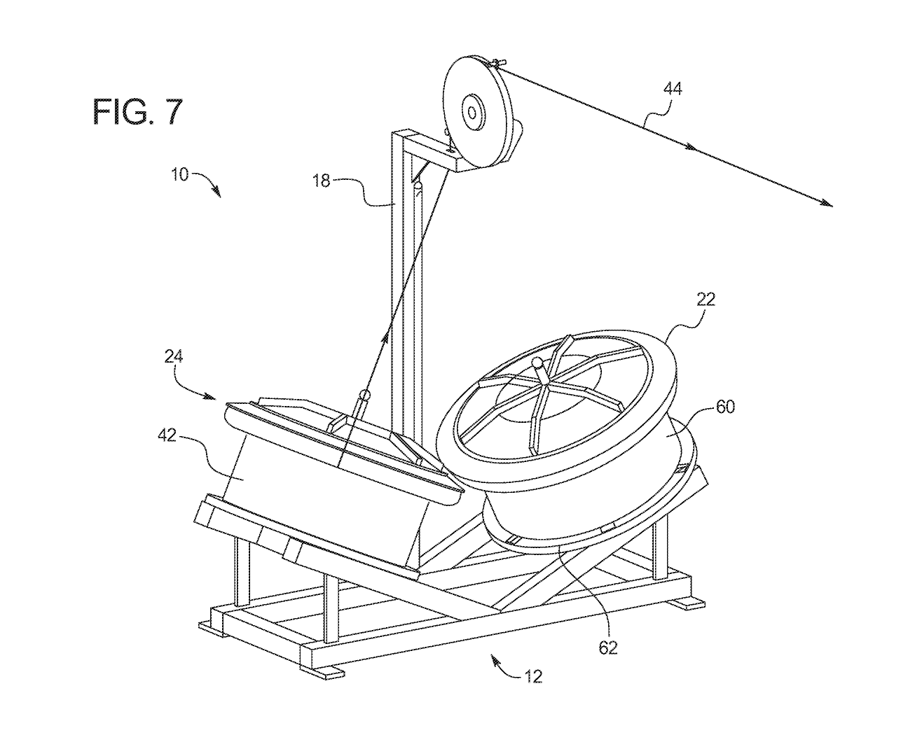

If operation of the bead wire payoff system 10 is to be continued after the second coil of bead wire 42 has been completely exhausted, a new coil of bead wire 60 may be placed on the first coil mount 22 to replace the spent first coil of bead wire 40, as shown in FIG. 7. The replacement of the first coil of bead wire 40 with the new coil of bead wire 60 may be performed while the bead wire payoff system 10 is still actively running and paying-off bead wire 44 from the second coil of bead wire 42. The lead end 62 of this new coil of bead wire can be attached to the back end (not shown) of the second coil of bead wire 42 such that when the second coil of bead wire 42 has been fully exhausted, operation will then automatically switch back over towards the first coil mount 22 and the new coil of bead wire 60 will begin to payoff. In addition to the new coil of bead wire 60, further coils of bead wire may continue to replace exhausted coils of bead wire on the first and second coil mounts 22, 24 while the other coil mount 22, 24 holds a coil of bead wire currently being unwound by the payoff system 10. In this manner, the bead wire payoff system 10 can continuously payoff bead wire without pausing to connect a new coil of bead wire, thus increasing the overall efficiency of the bead wire payoff system 10.

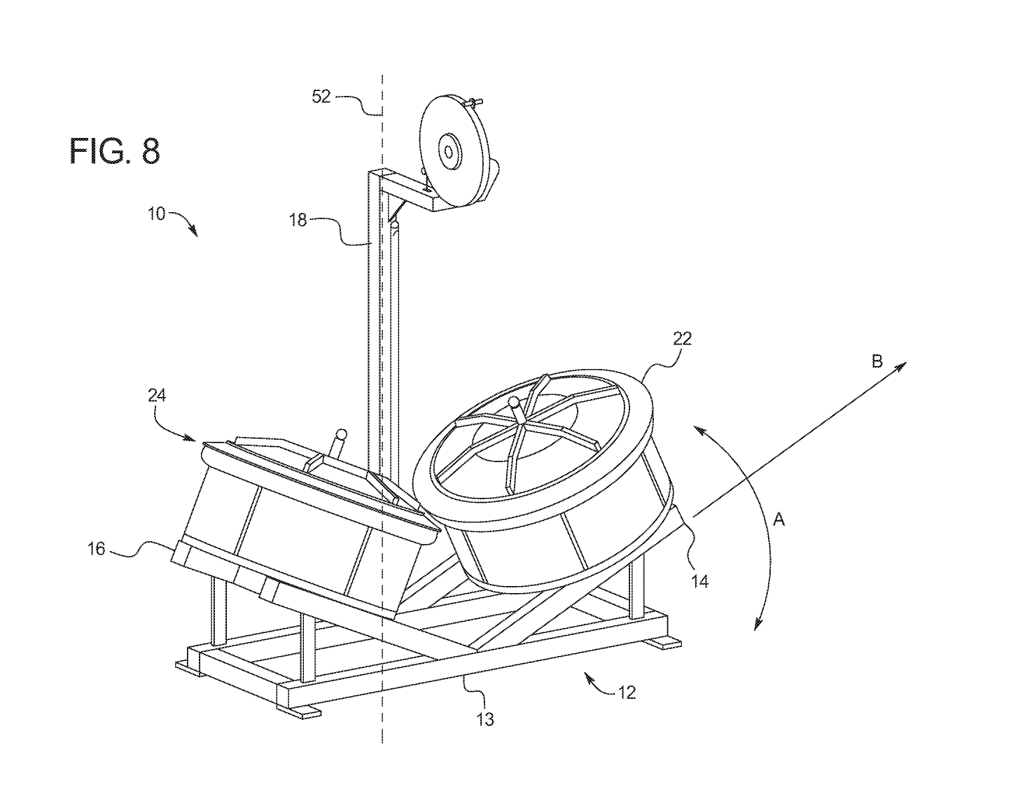

Replacement coils of bead wire may be installed on the first and second coil mounts 22, 24 by a variety of methods. Generally, the coils of bead wire may be placed with the assistance of gravity by first removing the first top flange 30 or second top flange 32 from their respective coil mounts 22, 24 and then by slowly lowering the coil of bead wire, with the assistance of a machine or by hand, onto the coil mount 22 or 24. FIG. 8 shows two additional aspects of the support structure 12 that, alone or in combination, may ease installation of new coils of bead wire while limiting any potential interference with the other coil that is currently paying off bead wire. In each of these additions, both the first and second coil supports 14, 16 of the horizontal support 13 can be moved, independently from the other between coil loading configuration and coil payoff configurations, to ease installation of new coils of bead wire. In one example, the first coil support 14, which in its coil payoff configuration is angled towards the centerline 52 of the bead wire payoff system 10, may be rotated downward in the A direction towards the coil loading configuration: a more horizontal, non-angled position. While the first coil support 14 is horizontal rather than angled, it may be easier to guide and install a new coil of bead wire on the first coil support 14. The second coil support 16 may also be manipulated in the same way, independently of the first coil support 14. Similarly, the first coil support 14 may be slid longitudinally in the B direction to move the first coil support 14, and thus the first coil mount 22, from the coil payoff configuration, away from the centerline 52 of the bead wire payoff system 10, and towards the coil loading configuration. This movement may allow for additional clearance between the first coil support 14 and the rest of the payoff system 10, thus allowing for an easier installation of a new coil of bead wire without fear or interfering with the continuous payoff from the other, already installed, coil of bead wire. The second coil support 16 may also be manipulated in the same way, independently of the first coil support 14. Further, the first and second coil supports 14, 16 may be designed to allow for movement in both longitudinal and angular movement in the B and A directions, respectively.

During the entire payoff operation, the coils of bead wire 40, 42, 60 that are loaded on the bead wire payoff system 10 may remain stationary and not rotate. Rather, a passive payoff system may be employed where tension is applied to the bead wire 44 by a payoff motor and the bead wire 44 is pulled off the stationary coils of bead wire 40, 42, 60. Thus, the bead wire 44, as it is being unwound, rotates around the axes of the coil mounts 22, thereby sliding around the top flanges 30, 32. The elimination of a driven, rotating payoff of the coils of bead wire 40, 42, 60 simplifies manufacturing and operation of the bead wire payoff system 10.

However, standard coils of bead wire may not work with the bead wire payoff system 10 described above. Known bead wire payoff systems utilize a driven payoff of bead wire where the coil of bead wire itself rotates as the bead wire is payed off. However, the bead wire payoff system 10 utilizes a passive payoff where the reel, or coil, of bead wire does not rotate. Because the bead wire 44 passively unwinds circumferentially around the top flanges 30, 32 of the coil mounts 22, 24, the unwound bead wire 44 naturally twists in an axial direction as it is being unwound. Essentially, the bead wire 44, as it is being unwound from the coil mounts 22, 24, twists axially 360 degrees for each full, 360 degree revolution around the coil mounts 22, 24. As the bead wire 44 continues to be unwound, more and more twists are formed in the unwound bead wire 44, which may eventually result in the bead wire 44 kinking, plastically deforming, or even disengaging altogether from the bead wire payoff system 10. Thus, the use of bead wire 44 in a passive payoff system as described above presents a unique challenge that may be solved by manufacturing and winding the coils of bead wire in a specific manner.

Specifically, the coils of bead wire 40, 42, 60 may be manufactured to have a built-in single axial twist per revolution. Essentially, as the bead wire 44 is wound into a coil, a single axial twist per revolution may be added. Thus, as the bead wire 44 is unwound from a coil of bead wire 40, 42, 60, an axial twist will not be added to the unwound bead wire 44 and instead the passive payoff system will instead remove the built-in axial twist from the unwound bead wire 44, thus causing a straight, non-twisted bead wire 44 to pay off from the coil of bead wire 40, 42, 60.

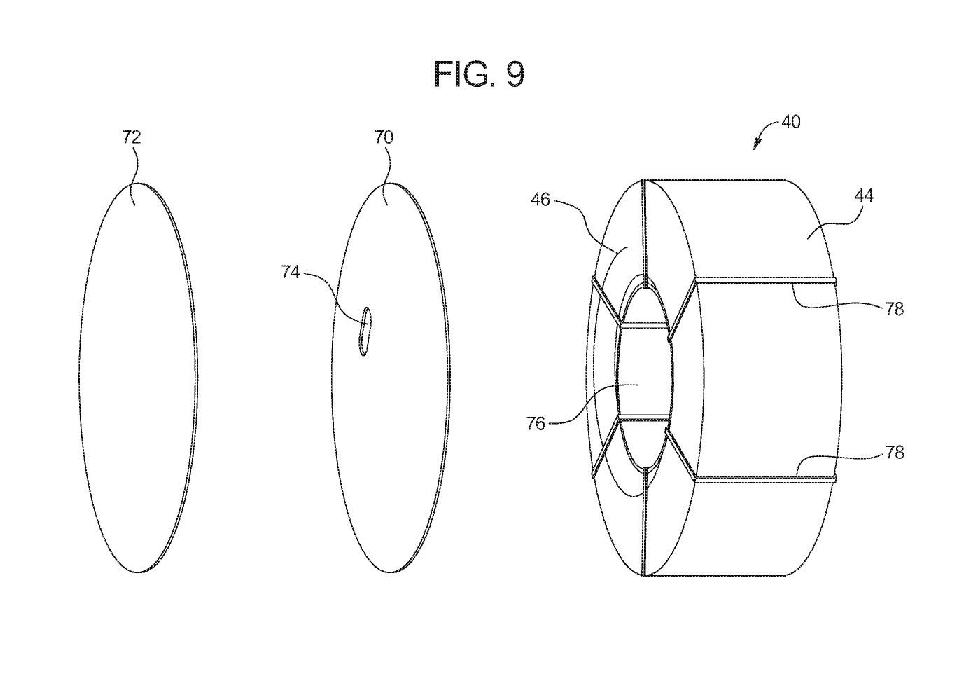

Another unique challenge for the coils of bead wire to be used with the bead wire payoff system 10 is the accessibility of the back end of the bead wire. With traditional bead wire payoff systems, the coils of bead wire are completely exhausted and then replaced. Thus, the back end of the coils of bead wire need not be exposed and accessible to an operator. However, since the bead wire payoff system 10 is designed to continuously payoff bead wire 44 by switching between two coil mounts 22, 24, the back ends of each coil of bead wire 44 that is to be used with the bead wire payoff system 10 must be exposed. For example, the first coil of bead wire 40 includes an exposed back end 46 as shown previously in FIG. 3 and now shown in FIG. 9. Manufacturing the first coil of bead wire 40 (in addition to all other coils of bead wire used with the bead wire payoff system 10) with an exposed back end 46 allows the back end 46 to be easily welded or otherwise attached to the lead end of another coil of wire, such as the lead end 48 of the second coil of wire 42 as shown in FIG. 3. If the back end 46 was not exposed as shown in FIG. 9, the advantageous continuous operation of the bead wire payoff system 10 would not be achievable.

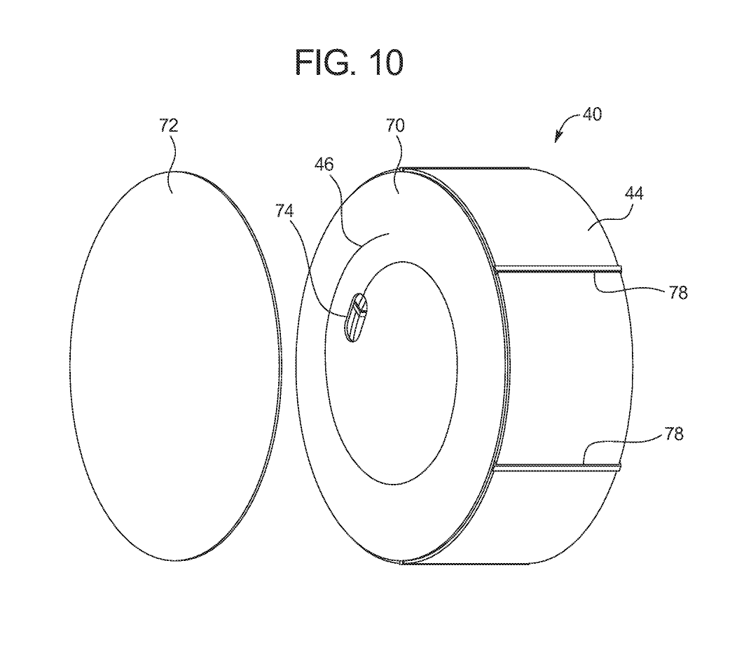

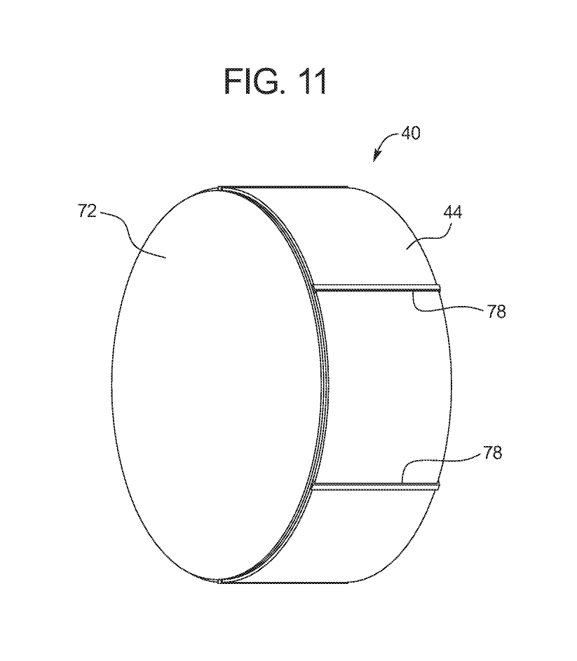

However, an exposed back end of a coil of bead wire can potentially lead to damage to the back end or to other parts of the coil of bead wire during shipment and delivery. Thus, it may be desirable to protect the coil of bead wire from this potential damage. In one example, as shown in FIGS. 9, 10, and 11, the back end 46 of the first coil of bead wire 40 may be protected with the use of an inner protector 70 and outer protector 72. The inner protector 70 may have an opening 74 through which the back end 46 may be fed, as shown in FIG. 10. The inner protector 70 may be positioned adjacent to the first coil of bead wire 40, and then the outer protector 72 may then be positioned over the first inner protector 70 to fully seal the back end 46 as shown in FIG. 11. The inner and outer protectors 70, 72 may be attached to the first coil of bead wire 40 in a variety of manners, including, but not limited to wrapping the entire coil of bead wire 40 in stretch wrap (not shown). The first coil of bead wire 40 may then be shipped as shown in FIG. 11. Once delivered, one or both of the protectors 70 and 72 may be removed prior to installation of the first coil of bead wire 40 on the bead wire payoff system 10 to expose the back end 46.

To simplify the use of coils of bead wire, the coils of bead wire may be transported and, eventually, unwound without the use of a spool. While traditional coils of bead wire are transported with and unwound from around a rigid central spool, these spools are heavy and expensive. Thus, upon exhaustion of bead wire from a spool, the empty spools are frequently shipped back to the manufacturer rather than just disposing of the spool, thus resulting in increased shipping costs. Instead, the first coil of bead wire 40 (along with any other coils of bead wire used with the bead wire payoff system 10) may be transported and unwound without a central spool or reel. Instead, as shown in FIG. 9, the bead wire 44 may be wound around a simple disposable core 76 made of a cheaper material such as cardboard that can be easily disposed after one use. When winding bead wire onto the disposable core 76, the disposable core 76 may be placed over a collapsible reel that stabilizes and supports the core 76 during the winding process. The bead wire may then be wound onto the disposable core 76 with the collapsible reel supporting the core 76. Once the bead wire has been wound onto the core 76, the collapsible reel may be collapsed and removed from the completed coil of bead wire. To further secure the first coil of wire 40 during shipment and storage, several bands 78 may be wrapped around the first coil of wire 40. After delivery and installation of the first coil of wire 40 on the bead wire payoff system 10, these bands 78 may be cut or otherwise removed to release the first coil of wire 40.

While the support frame 12 and first and second coil mounts 22, 24 shown in FIGS. 1 and 2 have specific designs and shapes, they are not so limited. Any support frame 12 capable of mounting and holding the first and second coil mounts 22, 24 is contemplated. Further, the first and second coil mounts 22, 24 may not require a support frame and instead may be individually placed adjacent to each other. Further, any design of first and second coil mounts 22, 24 that can support and allow replacement of coils of bead wire is contemplated. Further, any number of coil mounts in addition to the first and second coil mounts may be used, including using three or four total coil mounts that can be switched between each payoff bead wire.

While the embodiment described above shows the bead wire payoff system 10 as vertically floor-standing, the system is not so limited. Portions of, or all of, the bead wire payoff system 10 may be mounted on a wall, a ceiling, upside down, horizontally, and at various angles as desired.

Advantageously, the above described bead wire payoff system may result in increased machine productivity, less preventative maintenance, and less replacement of worn moving parts. The lack of moving parts may also result in increased safety and a reduction of noise. Further, since the entire coil of bead wire may be spent before transitioning to a new coil of bead wire, the amount of scrap bead wire may be reduced in comparison to conventional bead wire payoff systems.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A bead wire payoff system, comprising:
a first coil mount configured to receive a first coil of bead wire; and
a second coil mount configured to receive a second coil of bead wire;
wherein the first and second coil mounts are configured to continuously pay-off a bead wire, first from the first coil of bead wire, and then from the second coil of bead wire upon exhaustion of the first coil of bead wire.

2. The bead wire payoff system of claim 1, wherein:
the first coil mount is further configured to receive a third coil of bead wire to replace the first coil of bead wire upon exhaustion of the first coil of bead wire, wherein the first and second coil mounts are further configured to continuously pay-off a bead wire, first from the first coil of bead wire, then from the second coil of bead wire upon exhaustion of the first coil of bead wire, and then from the third coil of bead wire upon exhaustion of the second coil of bead wire.

3. The bead wire payoff system of claim 1, further comprising:
a support frame, wherein the first coil mount and second coil mount are attached to the support frame.

4. The bead wire payoff system of claim 3, wherein:
the support frame further comprises a horizontal support and a vertical support extending from the horizontal support, wherein the first coil mount and second coil mount are attached to the horizontal support, wherein a pulley is attached to the vertical support, the pulley configured to receive the bead wire payed-off from the first and second coil mounts and further configured to direct the bead wire towards an output.

5. The bead wire payoff system of claim 1, wherein:
the first coil mount comprises a first core and a first top flange, wherein the first top flange is configured to be removable to accommodate installation of the first coil of bead wire; and
the second coil mount comprises a second core and a second top flange, wherein the second top flange is configured to be removable to accommodate installation of the second coil of bead wire;

6. The bead wire payoff system of claim 1, wherein:
the first coil and second coil mounts are configured to passively pay-off the bead wire from the first and second coils of bead wire.

7. The bead wire payoff system of claim 1, wherein:
the first coil mount is movable between a coil loading configuration and a coil pay-off configuration independently of the second coil mount; and
the second coil mount is movable between a coil loading configuration and a coil pay-off configuration independently of the first coil mount.

8. The bead wire payoff system of claim 7, wherein:
the first coil mount is rotatable between the coil loading configuration and the coil pay-off configuration, wherein in the coil loading configuration the first coil mount is substantially horizontal, wherein in the coil pay-off configuration the first coil mount is angled towards a center line of the bead wire payoff system; and
the second coil mount is rotatable between the coil loading configuration and the coil pay-off configuration, wherein in the coil loading configuration the second coil mount is substantially horizontal, wherein in the coil pay-off configuration the second coil mount is angled towards the center line of the bead wire payoff system.

9. The bead wire payoff system of claim 7, wherein:
the first coil mount is slidable between the coil loading configuration and the coil pay-off configuration, wherein in the coil loading configuration the first coil mount is slid away from a center line of the bead wire payoff system and in the coil pay-off configuration the first coil mount is slid towards the center line; and
the second coil mount is slidable between the coil loading configuration and the coil pay-off configuration, wherein in the coil loading configuration the second coil mount is slid away from the center line of the bead wire payoff system and in the coil pay-off configuration the second coil mount is slid towards the center line.

10. The bead wire payoff system of claim 9, wherein:
the first coil mount is also rotatable between the coil loading configuration and the coil pay-off configuration, wherein in the coil loading configuration the first coil mount is substantially horizontal, wherein in the coil pay-off configuration the first coil mount is angled towards the center line of the bead wire payoff system; and
the second coil mount is also rotatable between the coil loading configuration and the coil pay-off configuration, wherein in the coil loading configuration the second coil mount is substantially horizontal, wherein in the coil pay-off configuration the second coil mount is angled towards the center line of the bead wire payoff system.

11. The bead wire payoff system of claim 1, wherein:
the second coil mount is configured to automatically begin paying-off the bead wire from the second coil of bead wire upon exhaustion of the first coil of bead wire via a back end of the first coil of bead wire attached to a lead end of the second coil of bead wire.

12. The bead wire payoff system of claim 2, wherein:
the second coil mount is configured to automatically begin paying-off the bead wire from the second coil of bead wire upon exhaustion of the first coil of bead wire via a back end of the first coil of bead wire attached to a lead end of the second coil of bead wire; and
the first coil mount is configured to automatically begin paying-off the bead wire from the third coil of bead wire upon exhaustion of the second coil of bead wire via a back end of the second coil of bead wire attached to a lead end of the third coil of bead wire.

13. The bead wire payoff system of claim 1, further comprising:
a first coil of bead wire attached to the first coil mount and a second coil of bead wire attached to the second coil mount.

14. A bead wire payoff system, comprising:
a first coil mount;
a first coil of bead wire attached to the first coil mount;
a second coil mount; and
a second coil of bead wire attached to the second coil mount;
wherein the first coil of bead wire is configured to pay-off a bead wire and the second coil of bead wire is configured to automatically begin paying-off the bead wire from the second coil of bead wire upon exhaustion of the first coil of bead wire;
wherein the bead wire is continuous from the first coil of bead wire to the second coil of bead wire.

15. A method of paying-off bead wire, comprising:
loading a first coil of bead wire on a first coil mount;
loading a second coil of bead wire on a second coil mount;
attaching a back end of the first coil of bead wire to a lead end of the second coil of bead wire;
paying-off a bead wire from the first coil of bead wire; and
paying-off the bead wire from the second coil of bead wire after the bead wire from the first coil of bead wire has been payed-off, wherein the bead wire is automatically payed off from the second coil of bead wire after the bead wire from the first coil of bead wire has been payed-off.

16. The method of claim 15, wherein:
the bead wire is passively payed-off from the first and second coils of bead wire, without rotation of the first and second coils of bead wire.

17. The method of claim 15, further comprising:
replacing the payed-off first coil of bead wire with a third coil of bead wire;
attaching a back end of the second coil of bead wire to a lead end of the third coil of bead wire; and
paying-off the bead wire from the third coil of bead wire after the bead wire from the second coil of bead wire has been payed-off, wherein the bead wire is automatically payed off from the third coil of bead wire after bead wire from the second coil of bead wire has been payed-off.

18. The method of claim 17, wherein:
the bead wire is passively payed-off from the first, second, and third coils of bead wire, without rotation of the first, second, and third coils of bead wire.

19. The method of claim 17, wherein:
the steps of replacing the payed-off first coil of bead wire and attaching a back end of the second coil of bead wire to a lead end of the third coil of bead wire are performed during the step of paying-off the bead wire from the second coil of bead wire.
